(19) United States
(12) Patent Application Publication
(10) Pub. No.: US 2014/0279211 A1
(43) Pub. Date: Sep. 18, 2014

(54) ELECTRONIC PAYMENT SOLUTION FOR EDUCATIONAL INSTITUTIONS

(71) Applicants: Bruber Financial Services, Inc. d/b/a BankCard Services Worldwide, (US); TECHNOLOGY INFORMATION EDUCATION SERVICES, Saint Paul, MN (US); ARUX SOFTWARE, INC., Woodbury, MN (US)

(72) Inventors: Herbert J. Bruber, Mendota Heights, MN (US); Chad C. Caswell, Lakeville, MN (US); Elizabeth A. Schweizer, Saint Paul, MN (US); Vincent S. Arnoldi, Woodbury, MN (US); Steven C. Novotny, Saint Paul, MN (US); Stephen L. Heuer, Minneapolis, MN (US)

(73) Assignees: Bruber Financial Services, Inc. d/b/a BankCard Services Worldwide, Saint Paul Park, MN (US); Arux Software, Inc., Woodbury, MN (US); Technology Information Education Services, Saint Paul, MN (US)

(21) Appl. No.: 13/829,502

(22) Filed: Mar. 14, 2013

(51) Int. Cl. G06Q 50/20

(52) U.S. Cl. CPC G06Q 50/2053; G06Q 30/0641
USPC 705/26.8

(57) ABSTRACT

Users of products and services of an educational institution make payments through an intelligent switchboard and an electronic payment solution. The user provides a user identity and is allowed access without needing further security requirement to access applications representing a set of offerings provided by the institution that differ in type of service, type of product, vendor, or payment type. The user views offerings of interest and makes selections based on the offerings. The user's selections are communicated to a universal checkout application that processes the offering selected and obtains payment and authorization from the user for an electronic payment transaction. A switchboard communicates with the users and communicates by an application program interface with each of the application programs and the universal checkout programs. This allows the user to pay for all selections, made within multiple applications, with a single payment experience. Status of the user's account with respect to the applications is updated based upon the payment transactions.

### BACKGROUND

As part of the educational services that they provide, educational institutions such as public and private schools, school districts, community colleges, colleges and universities provide a variety of offerings of services and products for which the student or the student's parent must pay. For example, for school aged children, the school may offer meal programs at lunch and in some cases breakfast. Rather than have the child bring money every day to purchase a meal, parents often wish to prepay for meals.

Another example is activity fees for athletics, music, and other extracurricular activities. The educational institution requires payment of the activity fees in order for the child to participate.

A ticket to sporting events and social events (e.g., prom tickets) is another example. Graduation cap and gown fees are often charged, and must be paid in advance. Some educational institutions charge parking fees for those students who drive.

In addition to these activities that are specific to younger students, educational institutions often offer community education to individuals of all ages. These are required for these educational programs, and often must be paid in advance along with registration for the class.

Another offering provided by some educational institutions is after school care for children. Payments may be required periodically.

These product and service offerings involve different types of service, different types of products, different vendors, and different types of payment. If done individually, the student or parent must make various payments at different times to different parties. This complicates the task for the student and parent, and also creates additional burdens on the educational institutions.

Electronic systems have been developed to allow a user (typically a parent) to make certain payments to an educational institution electronically. These systems typically make use of a website associated with the educational institution, where the user can check an account, determine what payments are due or are coming due, and make a payment electronically for particular services. Although these systems have simplified the payment process for both the parent and the educational institution, the payment process can still be challenging because the different services involve different accounts, different vendors, and different types of service or product. The timing of payments and the type of payments that are required also can vary from one offering to the next. Presently, the different offerings that can be accessed involve the parent providing different user credentials for each offering and separate payment experiences for each offering, which further complicates the process and makes it less attractive to users.

### SUMMARY

A method of providing an electronic education payment solution for products and services of an educational institution provides access to users of products or services of the educational institution. When a user communicates with the payment solution, a user identity for that user is obtained and is related to an account associated with the user. Without meeting any further security requirements, the user is allowed to access applications representing a set of offerings provided by the educational institution. The offerings may differ with respect to type of service, type of product, vendor, or type of payment. The user is provided navigation that allows the user to view offerings of interest to the user and to make selections based on those offerings. The selections are communicated by the user to a universal checkout application. An electronic payment transaction is processed related to the user's account in which all selections made by the user are paid for with a single payment by the user. Payment transaction information for the user's account is provided to the educational institution, and status of the user's account with respect to each of the applications affected by the transaction is updated.

A system for providing an electronic education payment solution for users of products or services of an educational institution includes a set of application programs, a universal checkout program, and a switchboard. The set of application programs represents service and product offerings of the educational institution that are available for purchase by users that had established an account. The universal checkout program processes selections made by a user from the offerings represented by the set of application programs and obtains payment information authorization from the user for an electronic payment transaction. The switchboard communicates with users and communicates by an application program interface with each of the application programs and with the universal checkout program. The switchboard facilitates navigation by users to allow users to view offerings and make selections based on the offerings. The switchboard provides users access to the offerings based upon each user providing a single user identity.

### BRIEF DESCRIPTION OF THE DRAWINGS

FIG. 1 is a block diagram illustrating a system for providing electronic educational payment solution for users of products and services of an educational institution.

FIG. 2 is a block diagram illustrating in greater detail the electronic educational payment solution of FIG. 1.

FIGS. 3A and 3B illustrate authentication and identity services, respectively, performed by a switchboard of the electronic educational payment solution.

FIG. 4 illustrates shopping cart services associated with universal checkout provided by the electronic educational payment solution.

FIGS. 5A-5P show examples of screens and messages presented to a user as the user navigates the electronic educational payment solution provided by the system of FIGS. 1 and 2.

### DETAILED DESCRIPTION

FIG. 1 shows online system 10, in which a user can connect into an online payment solution to purchase products and services offered by any educational institution, such as a public or private school, a school district, a community college, vocational schools, a college, or a university. In the following discussion, a school district will be used as an example of an educational institution, with the understanding that system 10 is applicable to all forms of educational institutions that provide a variety of offerings of services and products for which the student or student's parent must pay.

In this example, the user may be a parent of a single student or a number of students attending schools within the school district. Alternatively, the user may be an adult member of the community or region in which the school district resides, who wishes to participate in community education courses and activities offered through the school district, or who wishes to purchase tickets to concerts, sporting events, or other activities presented by the school district. For a user that is the parent of a child or children attending schools within the school district, the user may desire to pay online for meals for the students, to pay fees for sports, music or other activities, to pay for tickets to events for the students such as prom tickets, or to pay for after school care, or any other event requiring payments.

As shown in FIG. 1, system 10 includes user access point 12, Internet 14, school district website 16, and payment solution 18. User access point 12 is a web enabled device capable of accessing school district website 16 and payment solution 18 through Internet 14. School district website 16 is presented by a particular school district to offer information as well as service and product offerings to its constituency, which includes its students, faculty, parents of students, and the community or region that it serves. Although FIG. 1 shows only a single school district website 16 and a single user access point 12, payment solution 18 can provide services to many different school districts and other educational institutions, each of which has a unique set of service and product offerings available through its own unique website.

Although a user can access payment solution 18 directly through Internet 14, a first interaction between the user at user access point 12 and payment solution 18 typically happens with the user seeking information or service from the school district. The user accesses school district website 16 through Internet 14 and navigates school district website 16 to find a particular product or service of interest. Custom links within school district website 16 direct the user to payment solution 18. These custom links are specific to the particular school district website being accessed, so that the payment solution 18 is aware of which school district or other educational institution is involved. In that way, payment solution 18 can interact directly with the user at user access point 12 to provide the particular service and product offerings, and the pricing associated with those offerings that are unique to the particular school district associated with school district website 16.

Once the user at user access point 12 is connected into the web presence of payment solution 18, the context which that user belongs to which institution must be established. This involves authentication of the user, and establishing the user's identity.

User authentication occurs only once during the user's interaction with payment solution 18, regardless of which service or product is initially accessed or how many different services or products are purchased. Authentication can be done locally, (i.e., within payment solution 18) by the user providing his or her password that has previously been established with payment solution 18. Alternatively, if the user has accessed school district website 16 and payment solution 18 through a site that required a password, a third party authentication service provider can be used to permit access to payment solution 18.

Depending on the particular product or service selected by the user, authentication may be required immediately upon accessing payment solution 18, or may be required later. For example, if the user is interested in reviewing courses and activities offered through community education, payment solution 18 may allow user to browse information in a community education catalog first without authentication. Once the user indicates a desire to select a particular offering from the community education catalog, payment solution 18 will then require either third party authentication or the providing of the user's password.

Once the user has been authenticated, payment solution 18 uses an identity service to determine the user's identity. User identity data may be needed in order to determine what offerings from the school district are accessible by that particular user. For example, knowing the particular students associated with the user allows payment solution 18 to display information regarding the current balance of student meal accounts or the specific students associated with the user.

Once the user is at the website of payment solution 18, the user may navigate among the different offerings presented, which are those offerings of the school district that are accessible by that particular user. The user can move from one type of offering to another and can make selections from the various offerings, which are placed in a shopping cart. The different offerings selected can have different payment terms, involve different types of products or services, and can be offered by different vendors. Payment solution 18 provides a universal checkout, in which a user can pay for all of the selected products or services with a single electronic payment experience. Payment solution 18 handles the combining of the selected offerings into a single payment experience, and then unbundles the transaction so that portions of the payment can be allocated to the particular products or services that were purchased. This allows the individual product or service provider to receive payments, and the school district financial system to receive data needed to reflect the entire financial transaction and all of its components.

Payment solution 18, therefore, provides a way to provide the user with a consistent experience around security (authentication), identity, electronic shopping cart, and checkout. The user is allowed to move among different applications relating to different product and service offerings without having to provide a password for each different product or service. The use of a single shopping cart and a universal checkout involving only a single electronic payment simplifies the user's experience.

FIG. 2 is a block diagram of system 10, in which payment solution 18 is shown in further detail. In FIG. 2, system 10 includes user access point 12, Internet 14, school district website 16, payment solution 18, back office processor 20, and school district financial system 22. Payment solution 18 includes switchboard 24, offering applications 26, application program interfaces 28, and universal checkout 30. Offering applications 26 include meal account prepayments 26A, community education 26B, sports/activities 26C, tickets 26D, and after school care 26E. The particular offering applications 26 may vary from one educational institution to another, and may include service and product offerings different from those shown in FIG. 2. Offering applications 26 may be provided by different vendors. Each offering applications 26 is independent and has no awareness of the presence of any other offering applications 26. Offering applications 26 are stand alone applications, but are configured to conform to a common set of API rules referred to as “service contracts”. Once offering applications 26 conform to the service contracts, they are able to plug into switchboard 24 and consume the services provided by switchboard 24, which include authentication service, identity service, and cart service. In other words, each of the individual offering applications 26 no longer needs to perform authentication, identify of the user, or provide an electronic shopping cart. Instead, those functions are delegated by the individual offering applications 26 to switchboard 24. As each of those services is needed, switchboard 24 performs and provides the necessary service to the particular offering applications 26 through API 28.

Offering applications 26 also consume services from universal checkout 30. Because the checkout process is consolidated in universal checkout 30, rather than being performed individually by offering applications 26, the user is able to perform a consolidated or universal checkout in which all purchases are combined. This allows the user to have a single electronic payment experience to cover all of the purchases from the various offering applications 26.

Universal checkout 30 also consumes services from switchboard 24. These include the authentication, identity, and cart services.

After the single electronic payment is made through universal checkout 30, the single payment is separated into individual payments based on the particular services or products paid for with the single payment. The necessary financial, credit card, and bank processing takes place at back office processor 20, which acts as a payment transaction system in communication with both universal checkout 30 and school district financial system 22. Back office processor 20 can autopopulate school district financial system 22 with payment data. In addition, a reporting suite is made available by back office processor 20 to school district financial system 22, so that school district financial system 22 is aware of the payments that were made and the allocation of the payments to the particular offerings and accounts represented by offering applications 26.

As discussed previously with respect to the FIG. 1, the user typically accesses school district website 16, and then is routed to payment solution 18 by a custom link when the user selects a particular service or product offering. The custom link may be in the form of a custom URL that identifies the particular educational institution. For example, if school district website 16 is for school district XYZ, and the general URL for payment solution 18 is feepay.com, the custom URL may be districtXYZ.feepay.com. That custom URL will take the user to switchboard 24. Based upon the custom URL, switchboard 24 will limit the user's access to only those offering applications 26 that are associated with school district XYZ. Each educational institution will have an associated custom URL that identifies the institution and thereby identifies the institution's set of offering applications as well as the financial system of that particular institution.

FIG. 3A is a block diagram illustrating authentication of a user by payment solution 18. Authentication is performed by switchboard 24 as part of switchboard authentication service 40. The timing of authentication is determined by each of the offering applications 26, and is a part of the service contract between the particular application and switchboard 24. For example, meals application 26A may require that the user be authenticated before any access is provided to meals application 26A. In contrast, community education application 26B may allow the user to browse the community education course catalog without having to be authenticated. The user can browse anonymously within the course catalog, but will be required to authenticate once the user indicates a desire to select a particular course. If the user has not previously gone through authentication and established a user identity with switchboard 24, the service contract between community education application 26B and switchboard 24 will cause switchboard 24 to begin the authentication service with the user at that point.

Switchboard authentication service 40 determines authorization type 42, which may involve native authentication or third party authentication. Authentication type 42 may be selected by a user when first setting up an account with payment solution 18. Native authentication involves a password that is maintained by local authentication account 44 as part of payment solution 18. If the user has selected native authentication, then authentication service 40 requests that the user provide the password stored by local authentication account 44.

The user may select to provide authentication to switchboard authentication service 40 through a third party such as OAuth provider 46. In this case, the user provides authentication for having previously logged in on the web to third party site 48, such as Facebook, Twitter, or Google. If a third party authorization type has been selected, switchboard authentication service 40 delegates that authentication to OAuth provider 46.

Third party site 48 may create an interface that enumerates applications for which it will provide authentication services. The user can check his or her profile at third party site 48 to see that payment solution 18 is among the sites accepting third party authentication for that particular user. If the user wants to change the authentication source, change can be made at his or her profile at payment solution 18. The user will then either have to authenticate at payment solution 18 through another third party source, or make use of local authentication account 44.

FIG. 3B illustrates the establishment of an identity for the user within payment solution 18. Switchboard identification service 50 is responsible for gathering user identify data 52 stored in user identify data file 54. Identity data 52 is gathered by switchboard 24 when a user first sets up his or her account. The identity data may include user demographic data, user wallet information (such as name, home address, email address, and payment information) and user relationships (such as enrolled students, other children, and spouse). As part of providing identity information, the user will also choose an authentication model, either native authentication or third party authentication.

User wallet information, including payment information used for electronic payment, is needed by universal checkout 30. Other information such as user relationships is needed by meals application 26A, sports/activities application 26C and after school care application 26E. Tickets application 26D may also require relationship information if the user is purchasing tickets needed by students. On the other hand, community education application 26B may not need to know user relationships, but may require address and demographic information from the identity data.

FIG. 4 shows authentication service 40, identity service 50, and cart service 60 performed by switchboard 24, together with checkout service 70 performed by universal checkout 30. Card service 60 exists to allow the user to add items to a single shopping cart from any offering applications 26. Cart service 60 is part of the service contract between switchboard 24 and offering applications 26 in which offering applications 26 had delegated the shopping cart function to switchboard 24. As a result, the user can move from application-to-application and add selected offerings into that shopping cart. Cart service 60 keeps track of what items are in the cart, which offering applications 26 added those items to the cart, and what the price is of each item.

From a user interface perspective, a visual representation of the shopping cart is always available. When the user clicks on the cart icon, switchboard 24 shows the user all of the items currently in the cart, broken down by area or type, so that the user can see a simple representation of what is in the cart.

Universal checkout service 70 is launched when the user activates the checkout button. Checkout service 70, which is performed by universal checkout 30, draws upon authentication service 40, identity service 50, and cart service 60. Checkout service 70 needs to verify that the user has been authenticated by authentication service 40. It needs to inspect cart service 60 to see what kind of work will be needed as part of the checkout service. It also needs to draw from identity service 50 to fill in checkout forms that will be displayed to the user during the checkout process, thereby simplifying the checkout process for the user.

Checkout service 30 gathers the information necessary from the user, including the payment information needed for an electronic payment. Checkout service 70 determines, from the items in the shopping cart what the total amount is as well as how many individual transactions will be required in order to pay for all of the items in the cart. Checkout service 70 communicates the total to the user and proceeds with the electronic transactions needed to complete the total transaction. From the user's standpoint, the payment for all of the various items in the cart represents a single payment experience. Checkout service 70 communicates through gateway 80 with the third party electronic payment processor. Checkout service 70 inspects the results and communicates the results back to the user. The results may be an indication that the entire transaction went through, or that some or all parts of the transaction were declined.

Once the transaction is completed, checkout service 70 communicates with cart service 60 as to the results of the transaction. Cart service 60 then communicates the results back to the individual offering applications 26. If some parts of the transaction were not successful, cart service 60 will release a new instance of the cart with the unsuccessful items in the cart. This allows the user to go through the checkout process again for those items that were not successfully paid for in the previous transaction. This allows the user, for example, to use a different payment instrument, or to check to see if any of the information used for the transaction had been mis-keyed. This also allows the user to return to payment solution 18 at a later time and try the transaction again.

If the transaction has been successful, cart service 60 reports the successful transaction back to the appropriate offering applications 26, and those applications can be updated in real time. There is no delay, for example, in the student's ability to use his or her meal account after the transaction replenishing the account has been completed, i.e. once the payment data has reached the meal accounting software of application 26A.

The data for each transaction is stored in universal transaction store 90. The transaction data must be separated to reflect the different individual payment transactions. This includes settlement dates and transaction dates and all the details relating to what particular applications and application buckets (i.e., particular product or service offerings) are represented. The transaction data also includes account codes needed by the school district financial system to reflect the transactions. Back office processor 20 provides universal transaction reporting 100 to school district financial system 22, which represents a suite of reports based upon data from universal transaction store 90.

FIGS. 5A-5P show examples of screens and messages that can be presented to a user as the user navigates through payment solution 18. FIG. 5A shows screen 200, which is the first screen that appears when the user clicks on a custom link within school district website 16. That custom link brings the user to screen 200. In this particular example, two offering applications 26 are available, and are displayed on screen 200. Those offerings are meal accounts and activities/transportation. At the left end of top bar 202, Meals button 204 and Activities button 206 are shown, along with home page icon 208. At the right hand of top bar 202 is Sign In button 210.

FIG. 5B shows message box 212, which is superimposed on screen 200 when the user clicks on Sign In button 210. Sign In box 212 displays the user's email address 214, which in this case is feepaydemo@gmail.com. If the user has previously established an account with payment solution 18, the user will have selected either native authentication or third party authentication. If native authentication has been selected, the user enters a password in box 212. If the user has selected third party authentication, OAuth provider 46 provides the authentication based upon a password previously provided by the user in an existing account such as Facebook or Google. To proceed further, the user clicks Sign In button 216.

If the user has accessed payment solution 18 for the first time, the user will click Register a New Account button 218 on Sign In box 212. The user will go through a process of selecting native or third party authentication, and will provide user identity information used by switchboard 24 to perform user identity services.

FIG. 5C shows screen 220, which appears after the user has signed in. The user's account 222 (in this case “demo account”) appears on top bar 202. Shopping cart icon 224, with a listing of a number of items in the shopping cart appears next to demo account 222 on top bar 202.

FIG. 5D shows screen 226, which appears when the user clicks on Meals button 204. Screen 226 shows the account for “Antoinette Falk” which is a student identified as having a relationship with the user for the purpose of meal payments. Screen 226 shows a current balance and a recent history of purchases, as well as a bar graph showing daily purchases. Add Amount button 228 allows a user to add additional funds to the balance in the meal account for Antoinette Falk.

FIG. 5E shows screen 226 with message box 229 superimposed. Message box 229 identifies the student's name (Antoinette Falk), the account (meals), the current balance ($426.73), and an amount to be added that has been entered by the user ($10.00). The user then clicks on Add Amount button 230 to place the added amount in the shopping cart.

FIG. 5F shows the result of the user clicking Add Amount button 230 in FIG. 5E. Screen 226 once again appears, with drop down box 232 showing the status of the shopping cart. The $10.00 meal account payment is reflected in drop down box 232, and shopping cart icon 224 has been updated to indicate that the cart contains one item. If the user wishes to checkout at this point, Checkout button 234 is clicked. Otherwise, the user can navigate to other screens and to other offerings.

FIG. 5G shows screen 236, which is a result of the user clicking on Purchase History button 238. Screen 236 shows a listing of purchases by Antoinette Falk for a specified date range. The dates of purchases, the items purchased, and the amounts of those purchases are shown on screen 236.

FIG. 5H shows screen 240, which appears when the user clicks on Alerts and AutoPay button 242. In screen 240, information about two students (Antoinette Falk and Charlotte Falk) is shown. These two students are indicated as related to the user in the user identity information associated with the user's account. In FIG. 5H, box 244 authorizes an automatic payment of $10.00 when Antoinette's meal account drops below $25.00. Boxes 246 and 248 set conditions for sending alerts to the user when Charlotte's and Antoinette's meal accounts drop below specified levels. The user is given the opportunity to edit or remove the AutoPay instructions and the Alert instructions.

FIG. 5I shows screen 250, which appears when Activities button 206 on top bar 202 is clicked. The information shown on screen 250 relates to sign up information for particular activities. For Antoinette Falk, the activity requiring sign up is Running 2012-2013 at Sr. High Satellite Campus. An amount to be paid of $42.00 is stated. Add to cart button 252 can be clicked to add this activity to the shopping cart.

Charlotte Balk's activities include Chess Club 2012-2013 at Sr. High Satellite Campus. An amount to be paid of $42.00 is stated. For this activity, a form must be filled out as part of the transaction. Form button 254 must be clicked and a form filled out before this activity can be added to the shopping cart.

FIG. 5J shows screen 250 with message box 256 superimposed. Box 256 appears when the user has clicked Add to cart button 252 from Antoinette Falk's activities. The user is allowed to pay the variable amount (or a fixed amount), which is entered in box 256. The user may continue adding to the cart by clicking Continue Adding to Cart button 258.

FIG. 5K shows screen 250 after Continue Adding to Cart button 258 (FIG. 5J) has been clicked. The status of the shopping cart has been updated, as shown in box 260. Shopping cart icon 224 has been updated to reflect that two items now are present in the shopping cart. As shown in box 260, the two shopping cart items are a meal account payment and a payment for Antoinette Falk's running activity. These payments relate to two different offering applications 26, but are contained within a common shopping cart. The user can checkout at this point by clicking Checkout button 262, or may proceed to other screens within the activities application.

FIG. 5L shows screen 264, which appears as a result of the user clicking on Fees button 266. Fees for both Antoinette Falk and Charlotte Balk appear on screen 264. One of the items shown is a field trip to the MN Zoo with the amount of $15.00. Add to cart button 268 can be clicked to pay that fee.

FIG. 5M shows screen 264 after Add to cart button 268 has been clicked. Shopping cart icon 224 has been updated to indicate that three items are in the cart. Box 270 displays the current status of the shopping cart, which now includes a meal account payment selection, a selection for running, and a selection for a field trip. Checkout button 272 appears in box 270, and allows the user to checkout the contents of the shopping cart with a single payment experience.

FIG. 5N shows screen 274, which appears when the user has clicked on the Checkout button 272 in FIG. 5M. The contents of the shopping cart are itemized, and a screen containing information needed to make a credit card payment on line is displayed.

FIG. 5O shows screen 276, which is a sales order receipt supplied to the user by payment solution 18 when the electronic payment transaction has been completed. Confirmation is provided for each payment. The amounts relating to meals and the amounts relating to activities and fees, are shown and allocated to the particular items that were in the shopping cart. Shopping cart icon 224 appears on top bar 202, next to the user's account 222. Shopping cart icon 224 indicates that the shopping cart is now empty.

FIG. 5P shows screen 278, which is an example of a welcome screen for a user who has selected community education through school district website 16. Top bar 202 includes Community Ed button 280 as an option in addition to Meals button 204 and Activities button 206. The user can browse information such as a course catalog by clicking Browse All Programs button 282 without first going through authentication and providing a user identity. As discussed above, the user will be required to provide authentication once specific courses or other offerings are selected.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of providing an electronic education payment solution for users of products and services of an educational institution, the method comprising:
receiving communication from a user of products or services of the educational institution;
obtaining from the user a user identity;
relating the user identity to an account associated with the user;
allowing the user, without meeting further security requirements, to access applications representing a set of offerings provided by the educational institution that differ with respect to at least one of type of service, type of product, vendor, or type of payment;
providing navigation that allows the user to view offerings of interest to the user and to make selections based on the offerings;
communicating the selections made by the user to a universal checkout application;
processing an electronic payment transaction related to the user's account in which all selections are paid by the user through a single payment experience;
providing payment transaction information for the user's account to the education institution; and
updating status of the user's account with respect to each of the applications affected by the payment transaction.

2. The method of claim 1, wherein the selections made by the user are bundled in an electronic shopping cart for communication to the universal checkout application.

3. The method of claim 2, wherein the universal checkout application facilitates the single payment experience for all selected offerings.

4. A system for providing an electronic education payment solution for users of products and services of an educational institution, the system comprising:
a set of application programs representing service and product offerings of the educational institution that are available for purchase by users that have established an account;
a universal checkout program that processes selections made by a user from the offerings represented by the set of application programs and obtains payment information and authorization from the user for an electronic payment transaction; and
a switchboard for communicating with users of products or services of the educational institution and for communicating by an application program interface with each of the application programs and with the universal checkout program to facilitate navigation by users to allow users to view offerings and make selections based on the offerings, the switchboard providing access to users based upon each user providing a single authentication and user identity.

5. The system of claim 4, wherein an educational institution website, the switchboard and the application programs are related to one another by a domain name structure.

6. The system of claim 4 and further comprising:
a payment transaction system in communication with the universal checkout program for performing an electronic payment transaction for the user's account based on information from the universal checkout program, and for providing payment transaction data to a finance system of the school system.

7. The system of claim 6, wherein the universal checkout program allows offerings from different application programs to be paid with a single payment experience.

8. The system of claim 6, wherein the offering from different application programs differ in at least one of different products, different services, different vendors, or different payment types.

9. The system of claim 4, wherein the switchboard accepts a single user identity created on the switchboard or authenticated from another online security service.

10. The system of claim 4, wherein the switchboard comprises a common platform for accounts management, security, web assets, and a shopping cart.

11. The system of claim 10, wherein the accounts management allows the user to access an account associated with the user.

12. The system of claim 10, wherein the web assets provide switchboard navigational elements for guiding the user to selected applications.

13. The system of claim 10, wherein the shopping cart allows the user to bundle selections of offerings from different applications together for processing by the universal checkout program.

14. The system of claim 4, wherein the switchboard resides at a custom URL associated with the educational institution.

15. A system for providing an electronic education payment solution for users of products and services of an educational institution, the system comprising:
a set of application programs representing offerings of the educational institution that are available for purchase, the offerings representing at least one of different products, different services, different vendors, or different vendors;
a universal checkout program that processes selections made by a user from the offerings represented by the set of application programs and obtains payment information and authorization from the user for an electronic payment transaction in which all of the selections are purchased with a single payment experience; and
a switchboard for communicating with users of products or services of the educational institution and for communicating by an application program interface with each of the application programs and with the universal checkout program to facilitate navigation by users to allow users to view offerings and make selections based on the offerings, the switchboard providing access to users based upon a user authentication and user identity.

16. The system of claim 15, wherein the switchboard accepts a single user identity created on the switchboard or authenticated from another online security service.

17. The system of claim 15, wherein the switchboard comprises a common platform for accounts management, security, web assets, and a shopping cart.

18. The system of claim 17, wherein the accounts management allows the user to access an account associated with the user.

19. The system of claim 17, wherein the web assets provide switchboard navigational elements for guiding the user to selected applications.

20. The system of claim 15, wherein the application programs and the universal checkout program delegate authentication services, user identity services, and shopping cart services to the switchboard.
